(19) United States
(12) Patent Application Publication
(10) Pub. No.: US 2013/0061054 A1
(43) Pub. Date: Mar. 7, 2013

(54) METHOD TO CONTROL AND LIMIT READABILITY OF ELECTRONIC DOCUMENTS

(71) Applicant: C.K.D. CRYPTOGRAPHY KEY DATABANK SAG, Lugano (CH)

(72) Inventor: Giancarlo Niccolai, Bovisio Masciago (IT)

(73) Assignee: C.K.D. CRYPTOGRAPHY KEY DATABANK SAGL, Lugano (CH)

(21) Appl. No.: 13/666,019

(22) Filed: Nov. 1, 2012

Related U.S. Application Data
(63) Continuation of application No. PCT/EP2010/056014, filed on May 4, 2010.

(51) Int. Cl. G06F 21/24

(52) U.S. Cl. 713/171

(57) ABSTRACT

A series of data treatment processes, software applications and hardware devices jointly used to achieve the ability to make an electronic document available to the public or to a limited audience to either cease being readable, or start being readable, at a given moment in time or after a given event has occurred. A typical usage scenario consists in “automatic destruction” of documents used internally by an organization and that must be made unreadable after a certain project is complete. Conversely, public offers for auctions may be posted to all the participants and the issuer in an unreadable form, and made then readable after the deadline of the auction is expired. Again, documents may be made unreadable after a certain number of reads, or forwarded to a specific address under some conditions, or accessed only through well-known unmodified clients.

### REFERENCE DATA

The present application is a continuation of PCT/EP2010/056014 (WO2011137927) filed on May 4, 2010, the content whereof are hereby incorporated by reference.

### FIELD OF THE INVENTION

The present invention relates to methods of publishing electronic documents controlling at the same time their availability to public. In particular, but not exclusively, embodiments of the present invention relates to a series of data treatment processes, software applications and hardware devices jointly used to make an electronic document available to the public or to a limited audience to either cease being readable, or start being readable, at a given moment in time or after a given event has occurred.

### DESCRIPTION OF RELATED ART

Currently, there are various means to store or transmit a document safely through various cryptographic techniques. Symmetric cryptography can be made “theoretically safe” using variants of “one time pad” algorithm, that consists in using a key which contains at least the same amount of information as the target document, while more practical but less secure techniques can be employed to transfer documents across an untrusted network obviating the need of both side of the communication to share the same secret key.

Also, encryption and decryption of document is still today a process largely based on techniques involving the host computer generating a cipherdocument from the initial plaindocument on one side, and on the host computer decrypting the cipherdocument and reconstructing the plaindocument on the other.

In the context of public-key cryptography, centralized “certification authorities” have been technically realized and then institutionally established to certify the validity of a certain secret key used to generate relatively safe cipherdocuments to be propagated and deciphered, so that identity of the owner can be established in near-real-time all across the World Wide Web. Public-key cryptography allows to either ascertain the identity of the original sender of a document and/or generate a cipherdocument that can be read only by the selected audience. The introduction of the certification authorities had been a mean to certify the validity of the keys (that is, the real identity claimed to be associated with a given public-key) in the case that the parties of the communication are unknown to each other. Some certification authorities carry also the task to store some or all the keys that they certify, so that users can access them without the direct intervention of the key owner.

A notable gap in the widely available techniques to manage cryptographic data consists in the missing of a simple way for the writer of a document to control the ability of receivers to read the document under determined conditions of space and time which aren't related with the identity of the receiver, nor with its authorized or unauthorized possession of the needed decrypting devices.

Also, the most widely known techniques based on asymmetric cryptography algorithms, carry the intrinsic weakness of not being able to produce a theoretically secure result, able to resist even a hundred year or more of brute force attacks or other decrypting techniques that may be discovered in the meanwhile. This makes using currently existing asymmetric algorithms unsuitable to drive an application that requires to limit the availability of the key up to when a certain events occurs, as the information is theoretically still available also after the destruction of a cryptographic key allowing for direct decryption of the target document.

Conversely, commonly available cryptography algorithms that may grant theoretical security require symmetric cryptography which has two major drawbacks: it's highly vulnerable to man-in-the-middle attacks in case there is the need to exchange the key between the producer of the cipherdocument and some remote key holder, and it's vulnerable to partial brute-force attacks. Guessing a small part of the key is often enough to retrieve the desired part of the information of the original plaindocument.

### BRIEF SUMMARY OF THE INVENTION

There is therefore a need for a method of making an original document available in a safer manner and guarantee its integrity in time. According to the invention, these aims are achieved by means of the object of the appended claims.

### BRIEF DESCRIPTION OF THE DRAWINGS

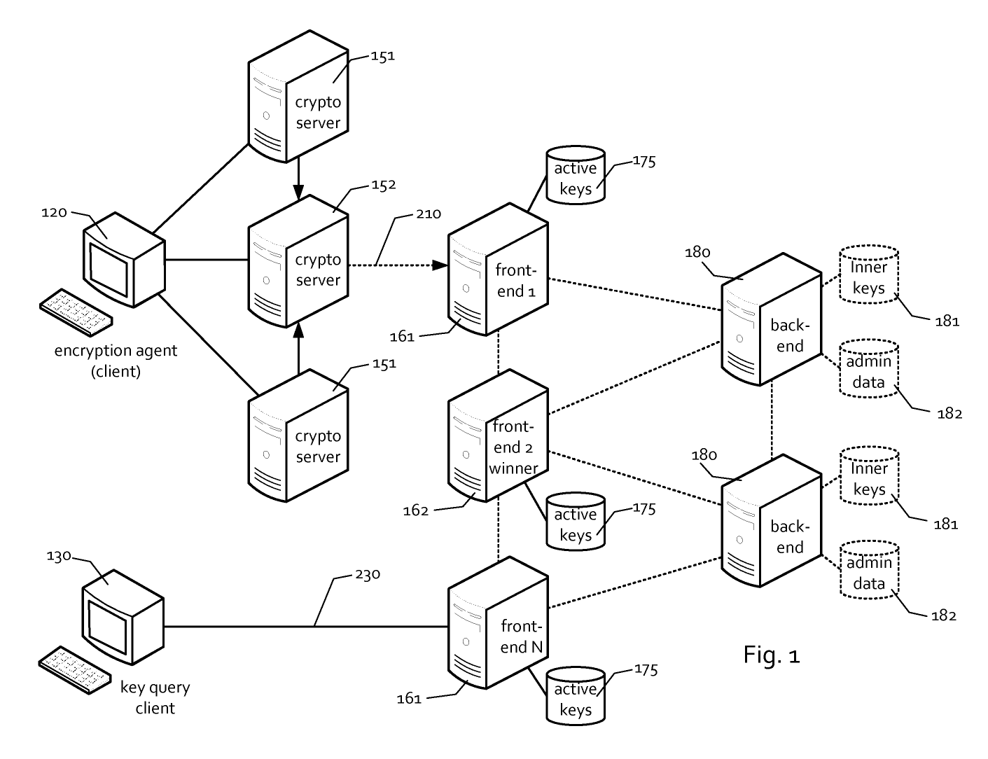

The invention will be better understood with the aid of the description of an embodiment given by way of example and illustrated by the FIG. 1 that illustrates, in simplified diagrammatic fashion, a system according to one aspect of the present invention.

### DETAILED DESCRIPTION OF POSSIBLE EMBODIMENTS OF THE INVENTION

The invention introduces the concept of cooperative cryptography, where a cipherdocument and the secret key that can be used to decipher it is created as an iterative process involving the computer system where the request is generated and a server or server network (in general, a cryptographic server system) where the request is fulfilled. Specularly, while it is possible for the original requester of the service to decide to make the key available to the public in every moment, it is also possible to force client applications to be assisted by the central servers during the decryption phase.

This makes possible to force the usage of a document only under a set of preliminary conditions that the original requester has established in advance, and that the cryptographic server system, in conjunction with specialized and certified client decryption applications, has the ability to enforce.

A typical usage scenario consists in “automatic destruction” of documents used internally by an organization and that must be made unreadable after a certain project is complete. Conversely, one can imagine several situations, for example the lodging of public offers for auctions, in which it is desirable that certain documents be posted to all the participants and the issuer in an unreadable form, and made then readable after the deadline of the auction is expired. The present invention is not however limited to these examples but encloses several variants in which a document is made readable or unreadable according to certain predefined publication rules. For example, documents may be made unreadable after a certain number of reads, or forwarded to a specific address under some conditions, or accessed only through well-known unmodified clients.

Besides this, this invention also relates to a new encryption algorithm which is functional to the cooperation between the encrypting and decrypting clients and the server system, based on a variation of the well known one-time pad algorithm, which uses keys and generates cipherdocuments having the following characteristics:
being easily splittable into chunks each transmissible on different possibly unprotected channels;
being resistant to cryptographic attacks for an undefined extent of time.
granting the validity and the integrity of the original document once that the key is applied to the cipherdocument, and that key and documents are tightly bound in pairs (or in other words, ensuring that it is not possible to generate arbitrary documents using a skillfully forged key document).

The invention system of the invention is composed, in a variant, of a set of interrelated components that are detailed below:
A theoretically safe cryptography system with the specific features of being splittable, resistant and granting integrity as described above.
A network of geographically distributed servers (cryptographic server system) which operate in coordination to safely transfer elements across endpoints of the process.
A distributed database to hold the data for an indefinite period of time in absolute safety.
A network accessible service that allows the clients to generate requests for cryptographic server system, that can be presented as:
   A network-based computer program oriented protocol (as i.e. RPC) for transmission of secret chunks or generation of key components.
   A world wide web based computer program interface (as i.e. JSON) for transmissions of secret chunks and generation of key components.
   A world wide web human user interface that can provide server-side only services or be integrated with generic and/or specialized web browser computer programs.

### A Theoretically Safe Cryptography System

The cryptography algorithm used by the present invention is a improvement of the known theoretically safe algorithm called “one time pad”. Basically, this algorithm consists in transforming one element of the original message through one element of the key. The algorithm proposed here is based on a similar working principle, but it adds extra securities and facilities, so that intercepting any part of the encrypted message is useless without all the other elements, and one single error in decoding the encrypted document makes the whole of it basically useless. This cares are taken both to prevent “Man In the Middle” decryption attacks and creation of an “inverted key” which may be used to generate an arbitrary document out of the elements that an attacker may be able to intercept.

A embodiment of the invention will now be described with reference to the figure. It includes an implementation of the theoretically safe cryptography system and of the distributed cryptographic servers system.

In a first step, the encryption agent application in charge of encrypting the document is instantiated in an encryption client 120. The encryption agent contacts one of the known crypto servers 151 over a suitable network, for example the Internet. In this step, the encryption agent 120 requests a worldwide unique session/document ID from the server 151. The server generates and returns the requested unique ID and also provides an array of addresses of globally distributed servers in the cryptographic server system that can be contacted later on to complete the other parts of the process; the encryption agent stores the received ID and must provide the received ID in every further communication with any of those server.

The document ID and other administrative data are written at the end of the original document, including but not limited to an electronic fingerprint that can be used to certify the original content of the document after decryption. At the very end of the document, the size of the original document is stored in reverse size-encoding (explained below).

Preferably, the entropy of the original document (OD) is maximized, for example with a known compression algorithm.

Preferably, the resulting compressed document (CD) is padded to a minimum length, for example 256 bytes or any other suitable value, to simplify the following steps.

Then, the compressed document (CD) is divided in a random number of blocks. Preferably the number of block and the size of individual blocks, albeit random, are limited between reasonable predetermined maximum and minimum values. For example the number of blocks could be limited between 64 and 65534 included, and must never be greater than the size of the compressed document divided 4, so that each block has a random size that can range between 4 and 65535 bytes. Various algorithms are available to efficiently break the document in random blocks as desired.

Each block is taken from the compressed document and copied to what will become the source document (SD). In front of each block, the size of the block and the ordinal number of the block in the compressed document are written sequentially using the size-encoding (explained below).

A random byte in the file is chosen as the start encryption position. The random position is immediately communicated to a random server in the array.

Preferably the encrypting agent can choose randomly between different encryption functions. For example the encrypting agent 120 picks one of the following functions at random: Binary XOR, Binary rotate addition, or Binary rotate subtraction. The agent 120 creates a variable that indicates the chosen encryption function and the size of the encryption block, for example a single byte where the two first bits indicate which encryption function is to be used, and the other 6 indicates the size of the encryption block, chosen at random between 1 and 63. This byte represents the start of an encryption block.

Then, a number of random bytes composing the key for an encryption block is asked to one of the random servers 151. The servers generate and store separately the number of the request and the generated key bytes. The bytes are then applied to the source document via the algorithm (binary xor, addition or subtraction) previously chosen.

The encryption block start and the encrypted bytes are written sequentially in the final document.

The operation repeats the steps above until the whole document is encrypted. Preferably when the end of the source document is hit during the encryption of a block, the agent continues taking the bytes from the beginning of the document. When the algorithm reaches a point in the file that is near to the start point (less than 64 bytes), a last block long exactly the detected distance is written. Care must be taken in those cases where this last block can occur across the end of the source files, that is, when the start point is in the first 64 bytes of the source file.

The document/session ID is recorded at the end of the encrypted data. The encryption agent 120 closes the session, informing all the previously contacted servers that the encryption is complete. If needed, they assemble it and store it in the database as described in the following.

Communication between the servers and the encryption agent can occur through a communication channel protected via a standard encryption mechanism (i.e. HTTPS), but it's not strictly necessary. To prevent man-in-the-middle attacks, the scrambling across different servers of the encryption requests is enough, except in the case where the attacks happens in a position where it is possible to intercept all the communication generated by the agent. Usage of a commonly available encrypted communication protocol, although considerably less robust than the algorithm indicated in this claim, further reduces the likelihood of man-in-the-middle attacks when this residual care is needed.

### Network of Servers

According to one aspect, the inventive system comprises a network of interconnected servers that cooperate serving a single request from different points of the world. The servers are in charge of:
Provide coordinated support to cooperative generation of the cryptography secret and cipherdocument, and more specifically:
Provide a globally unique ID to each encryption request (encryption-token).
   Provide streams of strongly random sequences to clients asking for them.
   Elect a central server in charge for the final storage of the key in the database.
   Transfer the part of the keys they have been generated to the elected server.
   Provide a distributed database of keys for decentralized and mirrored replication of the cryptographic secrets.
   Optionally, recording the activity of users of the system; more specifically:
      Tracking the activity generated by different users on a single secret
      performing punctual recording of the personal identity of users accessing the database, together with the network related data bound with each access (i.e. network request source address, access time, access duration and so on).
      Tracking the purpose for which each secret key is accessed.
      Tracking the means (more specifically, the client program) by which each access is performed. This step requires cooperation of client programs, which must declare their application fingerprint to the servers in a way specific of this particular network architecture.
      Perform accounting related to each access globally, independently of the specific server where each access is performed.

### Generation of the Cipherdocument

To provide a uniquely valid ID, each server receives a unique code, for example 3 readable ASCII characters, which is added to all the session IDs it generates.

Then, when an agent requests all the servers to conclude the transaction, the servers elect a final responsible for the document management. The election works as follows:
Each server communicates the workload (in terms of computational resources currently used) to the client that is requesting the connection.
The encryption agent (client) 120 knows how much key data it has received from each server, so it declares the winning server 152 by weighting the percentage of already known data by the current workload.
The winning server 152 and the total count of key blocks are communicated to all the crypto servers.
The ancillary servers 151 transfer the key parts to the winner 152 via a secure channel or a private connection. The server knowing it transfers also the key start position.
The winner assembles the key, stores it in the distributed database (arrow 210) transactions that, like this, are not visible to the encryption agent, are indicated by dashed arrows in FIG. 1. Subsequently the winner crypto server 151 reports success to the client 121, which must also wait for further confirmations from all the servers, as indicated below, but from this point on the key exists in the system and even if some further problem may arise, it's safely stored and ready to be used.
The winner and the ancillary servers 151, 152 also take care of storing the information about the item being created to all the database nodes. Every server communicates to all the nodes the existence of the keys; in case the session ID already exists it means that another server has already reported this fact.
The winner and each ancillary server communicate their “all green” message to the client when done. In case the client receives an error from one server (that may have not been able to communicate with the databases), it checks the all green messages from all the servers; if the error reported by one server isn't emended by any other server (i.e. if all the servers had problems with the same database, or if no other server had reported being in contact with the same database), then the client reports a warning to the user.
The servers detecting some error in the databases autonomously start an error reporting process so that the request ID can be manually added to the failing database by a human intervention.

### Validity Rules

The encryption process by the encryption client 120 is combined with the definition of a set of validity rules that determine the conditions under which the original document is to be made available; by way of example, the publication rules could include the following conditions, alone or in combination:
Make the original document available only after a predetermined publication date;
Make the original document available only before a predetermined revocation date;
Make the original document available only to selected requesters that have identified themselves and/or whose identity has been verified;
Make the original document available only to requester having a network address in a predetermined set of authorized addresses;
Make the original document available only after requests generated through a certified application;
Make the original document available only a predetermined number of times.

The above list is not exhaustive, however, and the invention could conceivably apply other rules. The rules are stored into the distributed database system of the invention and linked to the ID of the specific document to which they apply, so that the system can check their validity every time a decryption is requested, as it will be seen in the following.

### Distributed Database

Keys must be held safe in the database for years, ideally for more than one hundred years. Also, keys are very large (approximately the size of the compressed electronic document they are related to), so a database capable to store safely a large amount of static data is crucial to this system.

The database is ideally divided into two areas. The inner database is managed by a set of back-end servers 180 that are not directly available on the network and that can be reached only through the front-end servers. The outer database contains only the currently visible keys 175, or “active” keys (either those private for some users or those now available for everyone) and is directly at the disposal of the front-end servers 162.

Each of the inner and outer databases is again divided in two parts: the administrative tables and the physical key files. In FIG. 1, the administrative table for the inner database is labelled 182 and the keys are labelled 181. The same division exists, preferably, in the outer database, also, but is not displayed for simplicity. The administrative tables store the data accompanying each key: its session ID, its start point, the usage constraint (publication start or end date, number of usages left, particular events or conditions that trigger publication start or end apart the date), creator and possibly a list of entities that are authorized to use the key. The key files are for example stored as bare files in a high performance file system, in a directory tree hierarchy for faster indexing and retrieval. Each key is named after is unique session ID and stored in a directory of the named after the server ID where the key is assigned. Inside that directory, each key is stored under a certain number of directories named after the first part of the ID (past the unique server ID). The tree is organized so that each directory can contain no more than 10000 files (the number may change accordingly to optimal file system directory size).

The database is physically built as a set of nodes which are totally independent. Each node is comprises a back-end server program which receives complete keys and key notifications from the front-end servers, and can reply to retrieval requests for a determined key. Each inner server provides the following functions:
Key storage: keys are stored after a direct order of a winning front-end server. After the key is safely stored in a locally replicated filesystem (i.e. a RAID battery), the remote server is informed that the key has been introduced in the system.
Key propagation: after a request of a front-end server, the database server may be informed of the existence of a key in a remote database. Each server will periodically ask the server where the key was originally stored to send it to them too.
Key serving: if the server has a key, it is sent to the requesting entity, otherwise it returns the information about the server that currently holds it.
Batch processing: Key transfers from other servers and removal of old keys are periodic jobs that each database server handles autonomously.
Key activation: When a key becomes active (or immediately, if it's due to become inactive at some point in the future), the keys are sent to an outer database server and replicated through all the outer servers.

Outer servers 161, 162 work similarly to inner servers, but they are meant to store locally only the active keys. Contrarily to inner servers, they don't receive new keys directly from the cryptography servers 151, 152, but only from the inner database servers 180. Also, clients 120 connect directly to them to ask for keys.

### Coordinated Activity Tracking

In the cases where it is required to track the activity of a single client on a secret key for statistical record and accounting, a key access protocol is established between the servers being part of the network.

Not all the keys stored in the system are eligible for statistical recording or requires access tracking, either because they are declared “freely accessible” as a part of the rules regulating their disclosing, or because of the usage schema which may have a limited scope with respect of the functionalities offered by this system. In some cases, access tracking may be partial and require only a local tracking, without the global system tracking and accounting granted by the key access protocol.

The protocol is organized as follows:
As a client willing to access a stored key connects to a random server in the network, it transmits the credentials associated with its users and its application fingerprint to the server it connects to. The application fingerprint is transmitted in an encrypted form, possibly through the encryption method described earlier but also by other strong encryption means.
If the server cannot currently access directly the required key, the client is redirected to a front end server that is more likely to have a direct access to the key. However, if the key is not present in the system, this is immediately detected and the client is notified with an error response.
The server accepting the client request checks if its local knowledge of the status broadcasts a key usage claim to all the other servers in the inner database network; this independently of the fact that the key can be validly used or not (access account is to be globally performed even if the user cannot be granted desired access to the requested key).
If the front-end server has the ability to deny immediately a request, then the key usage claim is marked as “purely informative”, and back-end servers are not bound to reply. An error status is immediately notified to the client by the front-end server.
In all the other cases, all the back-end servers must update their account records and reply indicating whether the claim is granted to proceed or must be denied.
In case one or more of the back-end servers reply that the operation is forbidden, the front-end server closes the key usage claim with an “abort” status. Each back-end server records the activity, but resets its own account data (in the wait that they are replicated from the most updated server). In the meanwhile, the front-end server reports the error status to the client.

### Network Accessible Service

The cooperative cryptography service is meant to be both used tightly in conjunction with dedicated computer program applications and to publish services for third party users willing to use the features provided by a system provider without having to create one in-house server system.

Each of the following elements may be made available to public or distributed in a protected network with well-known existing means (private networks, firewall rules, Intranet systems etc.).

Notice that this means describe alternative ways to access the cryptographic servers system, and that some of this method may present different security levels and offer different performance and overall capabilities. In other words, not all the ways to access the system and use its service may have the same cryptographic strength or seamlessly provide the same options.

### Network Based Computer Program Oriented Protocol

The services can be distributed through a second-order server that acts as a client towards the cryptographic server system, while seen as a server by a final service user. In this model, the document is sent to the second-order server, together with the options for the key publications, through a protocol similar to the well-known HTTP/1.0. Options as key availability start-end dates, key usage, calling application fingerprint, decipher application fingerprint, identity elements of authorized key users and so on are sent in an header part, represented as colon separated key-value pairs, separated by a <CRLF> element. One mandatory element is the “Content-Length”, which declares the size of the document being sent after the header for remote cryptography.

On success, a success reply is returned together with the cipherdocument in the body of the reply.

Transmission of sensitive documents for remote cryptography may be performed on secure channels (encrypted virtual private networks, secure socket layer etc.) or via the cryptographic method described in this document.

In the latter case, a first header containing the total document length and the calling application fingerprint is sent; then, the real request is encrypted at client site through a unique pre-generated key associated with its fingerprint, and deciphered at host site after having accessed the shared key. This shared key is stored in the cryptographic server system and may be subject to the same set of validity rules that is applied to any key in the system (in fact, the second-order server acts as a standard client while asking for the client application key).

When the decryption of a cipherdocument is requested, a special decryption client is instantiated on a client 130 and a request for a key is transmitted to one of the outer server 161 (arrow 230). The server can determine the key requested from the unique document ID that is attached to the cipherdocument, and verify if the condition determined in the validity rules are met. If this is the case, the key is retrieved in the distributed database, and provided to the client 130, that decrypts the document. Alternatively, if the publication rules allow it, and/or if the communication 230 between the client 130 and the server 161 is sufficiently secure, the deciphering of the document could be done in the server.

### World Wide Web Based Computer Program Interface

Conceptually and structurally similar to the previous method, this method consists in a front-end, second order HTTP/1.x web server which hosts a Web2.0 programming interface and exposes a so-called Web-API to third party applications.

The Web-API consists of remotely callable functions that can be invoked to:
Request the cryptography of a document, and associate it with the validity options offered by the centralized system.
Query the status of the key for a certain cipher-document (i.e. when it will become available and/or when it will expire, count of possible usage, intended audience etc.).
Send a cipher-document to obtain the decrypted version.
Request a secret key (which can be distributed to the public because of its publication settings).

Due to the nature of the Web-API interface, security of sensitive document transmission can be granted only through well established and widely shared secure transfer protocols, as HTTPS, or other protocols that may become available in future.

### Web-Based User Interface

Similar to the other two methods, this third method is specifically oriented to human users willing to generate a cipherdocument out of an original document they possess, or to obtain a clear copy out of the cipherdocument they possess, if the authorization allows that.

Through the web-based interface, a user can upload the document to be encrypted to an intermediate server which acts as a client to the final cryptography server system, and associate it with the desired validity options (including means to force the intended audience to identify themselves, i.e. a passphrase the audience must know access the secret key).

The intended audience may then upload the cipherdocument, and eventually provide identification means so that the front-end server access the key database and returns the deciphered document to the user, provided the publication conditions are respected.

Due to the nature of this interface, this method to access the system is suitable only in those cases where the disclosure of the final document is not critical, at least not after the secret has been made public; or in those cases where the party receiving the cipherdocument can be trusted about not disclosing the contents of the document after having deciphered it.

Also, security of sensitive document transmission can be granted only through well established and widely shared secure transfer protocols, as HTTPS, or other protocols that may become available in future.

Examples of Applications and Uses of the Present Invention

A practical way to use the present invention is that providing a sort of electronic sealing-wax. Suppose that it is necessary to produce a copy of a document that must be held by a certain receiver or receivers, but not read until a certain condition occurs. For example, a private time-lengthy auction is usually held by sending the offers in a sealed envelope, which is open when certain predetermined terms are expired.

The electronic version that can be implemented through this invention allows each participant to crypt its offer and send the encrypted document to every other participant, other than to the seller. As the term for the auction lapses the keys used to crypt the offers become available and every participant can decrypt and read every other's offer.

Extending this to public auctions, the cipherdocument representing the sealed offer of every participant can be made available for download to the public; as the terms expire, every user can decipher each offer through a means as simple as web document upload, thus proving the transparency of the auctions proceedings against any form of abuse.

This system can also be used to ensure the identity of one or more recipients of a sensitive document. Suppose that the issuer of a sensitive document creates a cipherdocument and sends it to a set of recipients; it sets the count of possible usages of the keys to the same count of recipients. By checking the account status of the key, the sender is able to know which recipients are supposed to have read the document. When all the recipients have accessed the document, the key becomes unavailable, preventing leakage of the secret even if the cipherdocument is intercepted, and if the recipients communicate that they can't access the document, then it becomes at least known that the secret has been compromised.

Another application and use of the present invention consists of producing a client program that sends a secret to an unsafe terminal, as a cellular phone. By limiting the possible accesses to a key to one usage, the reader can read the encrypted message just once through a certified client application; after that, the document becomes useless despite the fact it may still exist on the phone in encrypted form.

Another application and use of the present invention is a self-shutting world-wide-web accessible hypertext page. A web content writer (i.e. a simple webmaster or possibly a blogger), may publish a particular content of its page through a web-application which decrypts a static encrypted content on-the-fly, in a non-textual representation (for example, a photo, a printout of a document, or a direct image rendering via text-to-graphic techniques that are now widely available). When the page expires, the contents of the plaindocument are not available anymore, even if the encrypted document that was used to generate the dynamic contents still exists in the backup of a web server that is not under the control of the blogger.

The same principle can be applied in reverse, pre-loading a content that must be made available only after a certain date.

Another practical way to use the present invention may consists in granting time-bound usage of software resources. A software house may use the system to decrypt on the fly functional elements of programs, or key elements of some database, or any digitally stored information whose access is desired to be limited, associating them with the status of a key that may be bound to precise contractual terms.

1. A method of making an original document available from one publisher to one or more recipients, comprising steps of:
Obtaining an encryption key from a server system,
Encrypting the original document into a cipherdocument in a manner that is determined by the content of the original document and by the encryption secret,
Defining a set of validity rules that determine the conditions under which the original document is to be made available,
Transmitting the cipherdocument to the recipient or to the recipients,
Transmitting a decryption key to the recipient, only when the conditions determined in the validity rules are met,
decrypting the cipherdocument to reconstruct the original document in a manner that is determined by the decryption key, in which the validity rules that determine the conditions under which the original document is made available include one or more of the following conditions:
transmit the decryption key only after a predetermined publication
date;
transmit the decryption key only before a predetermined revocation date.

2. The method of the claim 1, further comprising a step of splitting the original document into a plurality of blocks having a determined length or a random length, wherein the step of obtaining an encryption key includes steps of obtaining an encryption secret key for each block.

3. The method of claim 2, in which the server system includes a plurality of interconnected servers, the encryption secret keys being obtained from different servers.

4. The method of claim 2, wherein the encrypting steps comprises a step of selecting a different theoretically safe encryption function for each block.

5. The method of claim 4, in which the encryption functions are based on the one-time pad method.

6. The method of claim 1, comprising a step of assigning a unique identifying code to the cipherdocument.

7. The method of claim 1, in which the validity rules that determine the conditions under which the original document is made available include one or more of the following conditions:
transmit the decryption key only after the requester has identified himself and his identity has been verified;
transmit the decryption key only to requester having a network address in a predetermined set of authorized addresses;
transmit the decryption key only after requests generated through a certified application;
transmit the decryption key only a predetermined number of times.

8. The method of claim 1, comprising the step of recording the activity of remotely accessing the secret as well as recording identity and purpose of the users of the secret.

9. A system comprising a plurality of interconnected servers, arranged to provide encryption and decryption secrets and to perform the steps of:
obtaining an encryption key from a server system;
encrypting the original document into a cipherdocument in a manner that is determined by the content of the original document and by the encryption secret;
defining a set of validity rules that determine the conditions under which the original document is to be made available;
transmitting the cipherdocument to the recipient or to the recipients, transmitting a decryption key to the recipient, only when the conditions determined in the validity rules are met;
decrypting the cipherdocument to reconstruct the original document in a manner that is determined by the decryption key, in which the validity rules that determine the conditions under which the original document is made available include one or more of the following conditions:
transmit the decryption key only after a predetermined publication date;
transmit the decryption key only before a predetermined revocation date.

10. A computer program products including computer readable non-transitory media storing a software code executable by a computer or by a distributed computing system, that cause that computer or that distributed computing system to perform the steps of:
obtaining an encryption key from a server system;
encrypting the original document into a cipherdocument in a manner that is determined by the content of the original document and by the encryption secret;
defining a set of validity rules that determine the conditions under which the original document is to be made available;
transmitting the cipherdocument to the recipient or to the recipients, transmitting a decryption key to the recipient, only when the conditions determined in the validity rules are met;
decrypting the cipherdocument to reconstruct the original document in a manner that is determined by the decryption key, in which the validity rules that determine the conditions under which the original document is made available include one or more of the following conditions:
transmit the decryption key only after a predetermined publication date;
transmit the decryption key only before a predetermined revocation date.

11. The computer program product of claim 10 comprising software means to implement a remote procedure call protocol.

12. The computer program product of claim 10, comprising software means to implement a World Wide Web interface that can be accessed by users and other world wide web aware computer program products.
